(19) United States
(12) Patent Application Publication
(10) Pub. No.: US 2011/0056090 A1
(43) Pub. Date: Mar. 10, 2011

(54) WOOD MATERIAL DRYING PLANT COMPRISING A ROTARY DRYER

(75) Inventors: Ola Larsson, Vaxjo (SE); Peter Lindahl, Vaxjo (SE); Cristian Bohman, Vaxjo (SE)

(73) Assignee: Andrtitz Technology and Asset Management GmbH, Graz (AT)

(21) Appl. No.: 12/858,051

(22) Filed: Aug. 17, 2010

(30) Foreign Application Priority Data
Sep. 7, 2009 (SE) 0950639-5

(51) Int. Cl. F26B 3/02; F26B 11/02

(52) U.S. Cl. 34/499; 34/134

(57) ABSTRACT

A wood material drying plant including a heater for generating a hot drying gas, a rotary dryer for bringing the hot drying gas into contact with the wood material to be dried, a wood particle separating unit being operative for separating entrained wood particles from the spent drying gas, and a gas cleaning system for removing pollutants from the spent drying gas. The wood material drying plant is provided with a heating gas duct which is operative for forwarding a gas portion to a mixing position located between the rotating drum of the rotary dryer and the wood particle separating unit, said gas portion having a higher temperature than the spent drying gas, and for mixing said gas portion with said spent drying gas, such that the temperature of the spent drying gas is increased.

### RELATED APPLICATIONS

This application claims priority to Swedish patent application 0950639-5 filed on Sep. 7, 2009, the entirety of which is incorporated by reference.

### FIELD OF THE INVENTION

The present invention relates to a wood material drying plant being operative for drying a wood material and comprising a heater for generating a hot drying gas, a rotary dryer for bringing, in a rotating drum thereof, the hot drying gas into contact with the wood material to be dried, a wood particle separating unit being operative for separating entrained wood particles from the spent drying gas, and a gas cleaning system for removing pollutants from the spent drying gas.

The present invention further relates to a method of controlling the operation of a wood material drying plant.

### BACKGROUND OF THE INVENTION

In the production of dried wood products, including, for example, pellets, also referred to as fuel pellets, a wood material, such as wood chips, wood saw dust etc., is dried in a dryer, and is then forwarded to a device for further processing of the dried wood material. The drying process may be conducted in a rotary dryer in which the wood material is transported in a rotating drum through which a hot drying gas is forwarded. The rotation of the drum yields a beneficial mixing of the wood material and the hot drying gas, yielding an efficient drying of the wood material.

The drying process in the rotary dryer volatilizes not only water vapour from the wood material but also volatile organic substances, such as terpenes. The volatile organic substances may cause problems in downstream equipment which is operative for cleaning the spent drying gas leaving the rotary dryer. U.S. Pat. No. 5,603,751 discloses one process in which the spent drying gas leaving the rotary dryer is cleaned in a fabric filter. To avoid problems of condensation of volatile organic substances in the fabric filter, a portion of the gas that has been cleaned in the fabric filter is heated and is added just upstream of the fabric filter to ensure that the fabric filter operates at a sufficiently high temperature to avoid any problems of condensation. The operation of the fabric filter of U.S. Pat. No. 5,603,751 is, however, expensive and still causes some problems with condensation of volatile organic substances.

### SUMMARY OF THE INVENTION

A novel wood material drying plant has been conceived which is efficient with regard to the energy consumption, and which substantially reduces operating problems.

The wood material drying plant is operative for drying a wood material and comprises a heater for generating a hot drying gas, a rotary dryer for bringing, in a rotating drum thereof, the hot drying gas into contact with the wood material to be dried, a wood particle separating unit being operative for separating entrained wood particles from the spent drying gas, and a gas cleaning system for removing pollutants from the spent drying gas, the wood material drying plant being provided with a heating gas duct which is operative for forwarding a gas portion to a mixing position (P) located between the rotating drum of the rotary dryer and the wood particle separating unit, said gas portion having a higher temperature than the spent drying gas, and for mixing said gas portion with said spent drying gas, such that the temperature of the spent drying gas is increased.

An advantage of this wood material drying plant is that condensation of volatile organic substances is avoided, or is at least very limited, in the wood particle separating unit. This reduces maintenance work and downtime.

According to one embodiment, the wood material drying plant further comprises a first temperature sensor being operative for measuring the temperature of the spent drying gas upstream of said mixing position (P) to which the gas portion is forwarded, and a second temperature sensor being operative for measuring the temperature of the spent drying gas downstream of said mixing position (P) to which the gas portion is forwarded, a control unit being operative for controlling the amount and/or the temperature of the gas portion being forwarded to said mixing position (P) based on the temperatures measured by said first and second temperature sensors. An advantage of this embodiment is that control of the amount and/or temperature of the forwarded gas portion becomes very accurate, such that a good energy efficiency is obtained.

According to one embodiment said heating gas duct is operative for forwarding the gas portion from the heater generating the hot drying gas for the rotary dryer to said mixing position (P). An advantage of this embodiment is that the investment cost becomes low, since no separate heater is required in addition to the one that is in anyway required for providing hot drying gas for the rotary dryer.

In accordance with one embodiment the heating gas duct is operative for forwarding the gas portion to a rotary dryer drop out chamber in which at least a portion of the dried wood material is separated from the spent drying gas. An advantage of this embodiment is that the gas portion can be mixed with the spent drying gas without heating also the main portion of the wood material. According to one preferred embodiment the heating gas duct is connected to a ring shaped duct at least partly encircling the drop out chamber and being operative for supplying the gas portion around at least a part of the periphery of the drop out chamber. This provides for a very small risk that volatile organic substances are condensed on the walls of any device or duct coming into contact with the spent drying gas.

According to one embodiment the gas cleaning system comprises a wet cleaning device, being operative for cooling the spent drying gas by means of mixing the spent drying gas with water and for removing condensed volatile organic substances from the spent drying gas. An advantage of this embodiment is that volatile organic substances are condensed in one very specific position in the wood material drying plant, and are mixed with water, making them less prone to sticking to surfaces, and easier to handle.

According to one embodiment a recirculated gas duct is connected to said heating gas duct and is operative for mixing an amount of recirculated spent drying gas into the gas portion being forwarded to the mixing position. An advantage of this embodiment is that the temperature of the gas portion can be controlled.

An efficient method of controlling the operation of a wood material drying plant may be achieved by means of a method of controlling the operation of a wood material drying plant of the above referenced type, the method comprising the steps of:

forwarding a gas portion to a mixing position being located between the rotating drum of the rotary dryer and the wood material separating unit, and

mixing the gas portion, having a higher temperature than the spent drying gas leaving the rotating drum of the rotary dryer, with the spent drying gas to increase the temperature of the spent drying gas.

An advantage of this method is that, using a small amount of energy, unwanted condensation of volatile organic substances in the wood particle separating unit can be avoided, or substantially decreased.

According to one embodiment the method comprises measuring the temperature of the spent drying gas upstream of said mixing position, measuring the temperature of the mixture of the spent drying gas and said gas portion downstream of the mixing position, and controlling the amount and/or the temperature of the gas portion being forwarded to the mixing position in view of said temperatures.

According to one embodiment said gas portion is forwarded to the mixing position from the heater generating the hot drying gas for the rotary dryer.

According to one embodiment the amount and/or temperature of the gas portion being forwarded to the mixing position is controlled so as to increase the temperature of the spent drying gas leaving the rotating drum of the rotary dryer by 10-50° C., preferably by 10-30° C. An advantage of this embodiment is that unwanted condensation of volatile organic substances is efficiently avoided, or substantially decreased, with a low amount of energy being utilized in the forwarded gas portion. Increasing the temperature by less than 10° C. means that the risk is still rather large that unwanted condensation may occur. Increasing the temperature by more than 50° C. means that the amount of energy used is increased substantially.

According to one embodiment at least a portion of the mixture of the spent drying gas and the gas portion is recirculated, from a position located downstream of said mixing position, to the heater or to the heating gas duct forwarding the gas portion from the heater to the mixing position. An advantage of this embodiment is that at least a portion of the energy content of the gas portion being forwarded to the mixing position is reused.

A wood material drying plant is disclosed comprising: a source of drying gas; a rotary drum dryer receiving the drying gas from the source and receiving a wood material and discharges the wood material and spent drying gas to a discharge conduit, wherein the wood material is dried by the drying gas in the rotary drum dryer; a wood particle separating unit coupled to the discharge conduit and separating entrained wood particles from the spent drying gas; a heating gas duct directing a gas portion to the discharge conduit; a mixing position in the discharge conduit at which the gas portion from the heating gas duct mixes with the spent drying gas from the rotary drum, wherein the gas portion is at a higher temperature than the spent drying gas, and wherein heat from the gas portion to the spent drying gas at the mixing position (P) in the discharge conduit. The wood material drying plant may further comprise a first temperature sensor measuring a temperature of the spent drying gas upstream of said mixing position (P) and a second temperature sensor measuring the temperature of the spent drying gas downstream of said mixing position (P), and a control unit controlling the amount and/or the temperature of the gas portion flowing to said mixing position (P) based on the temperatures measured by said first and second temperature sensors. In addition, the discharge conduit may include a drop out chamber and at least one conduit connecting the rotary drum dryer, drop out chamber and wood particle separating unit. Further, the gas portion may be hot gas from the source of drying gas.

Further objects and features of the present invention will be apparent from the description and the claims.

### BRIEF DESCRIPTION OF THE DRAWINGS

An exemplary embodiment of the invention will now be described in more detail with reference to the appended drawings in which:

FIG. 1 is a schematic side view, and illustrates a wood material drying plant.

FIG. 2 is an enlarged schematic side view, and illustrates a control system of the wood material drying plant.

FIG. 3 is an enlarged schematic side view, and illustrates a drop out chamber of a rotary dryer.

FIG. 4 is an enlarged schematic side view, and illustrates a wet electrostatic precipitator.

### DESCRIPTION OF EMBODIMENTS OF INVENTION

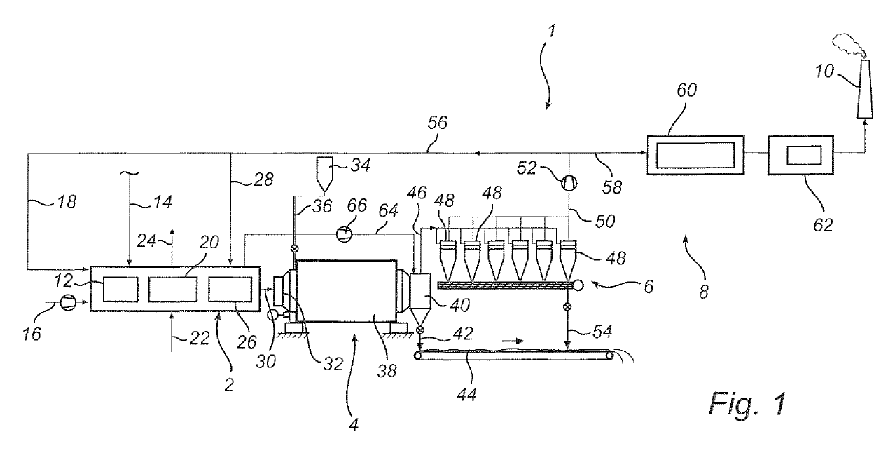

FIG. 1 illustrates a wood material drying plant 1 which is operative for drying wood material, such as wood chips and particulate wood material, prior to the further processing of the same for forming wood products, such as fuel pellets. The main components of the drying plant 1 are a heater 2, which is operative for providing a hot drying gas, and a rotary dryer 4, which is operative for bringing the hot drying gas into contact with the wood material to dry the latter, and for separating the major portion of the dried wood material from the spent drying gas. The wood material drying plant 1 further comprises a wood particle separating unit 6, which is operative for separating entrained wood particles from the spent drying gas downstream of the rotary dryer 4, and a gas cleaning system 8, which is operative for cleaning the spent drying gas, such that the spent drying gas may be admitted to the atmosphere via a stack 10.

The heater 2 comprises a burner 12 in which a fuel, such as bark, supplied via a supply line 14, is combusted. Air is supplied to the burner 12 via an air supply duct 16, and recirculated spent drying gas is supplied to the burner 12 via a recirculated drying gas duct 18. The combustion of the fuel in the burner 12 results in a hot drying gas having a temperature of typically 700-1000° C.

Optionally, the heater 2 may be provided with a hot oil generator or a steam generator 20 which is located downstream of the burner 12, as seen with respect to the flow direction of the hot drying gas, and in which the hot drying gas is utilized for heating oil or water, as the case may be, supplied via a pipe 22, to generate steam, or hot oil, leaving the generator 20 via a pipe 24 and being utilized in downstream equipment treating the dried wood material.

Furthermore, and also optionally, the heater 2 may be provided with a mixing chamber 26. The mixing chamber 26 is operative for mixing the hot drying gas coming directly from the burner 12, or coming via the steam generator 20, as the case may be, with recirculated spent drying gas coming from a recirculated drying gas duct 28. The purpose of such mixing is to reduce the temperature of the hot drying gas, to obtain better conditions for the drying, and to obtain an improved energy economy of the drying plant 1.

The hot drying gas leaving the mixing chamber 26 typically has a temperature of 300-600° C. and is forwarded, via a duct 30, to the inlet zone 32 of the rotary dryer 4. In the inlet zone 32 the hot drying gas forwarded via the duct 30 is mixed with wet wood material supplied from a storage facility, such as a silo 34, via a transport duct 36.

The rotary dryer 4 further comprises a rotating drum 38 and a drop out chamber 40. The drum 38 is made to rotate and brings the wet wood material into thorough contact with the hot drying gas. The rotating drum 38 forwards the dried wood material to the drop out chamber 40, which will be described in more detail hereinafter. The major portion of the dried wood material, typically corresponding to at least 90%, and often 95-99.99%, of the total weight of the wood material dried in the rotary dryer 4, is collected in the drop out chamber 40, leaves the bottom of the drop out chamber 40 via a pipe 42, and ends up on a transport belt 44 being operative for transporting the dried wood material to a not shown treatment plant, for example a pelletizing plant, for the further treatment of the dried wood material.

The spent drying gas, containing also entrained wood particles and some solid residues from the combustion in the burner 12, leaves the drop out chamber 40 via a pipe 46 and is forwarded to the wood particle separating unit 6. The wood particle separating unit 6 comprises at least one cyclone 48, and typically a number of parallel cyclones as shown in FIG. 1, for example 2-20 parallel cyclones 48. An example of such a cyclone 48 is disclosed in U.S. Pat. No. 6,997,973, the contents of which are hereby incorporated in its entirety by this reference. An outlet duct 50 is connected to each of the cyclones 48 and to a fan 52 which is operative for providing such a suction in the cyclones 48 that a desired removal of entrained wood particles and solid residues from the spent drying gas is obtained in accordance with the well known cyclone effect. In the cyclones 48 most of the wood particles are separated from the spent drying gas and leaves the cyclones 48 via a pipe 54, which is operative for forwarding the removed wood particles to the transport belt 44 transporting the dried wood material to, for example, a pelletizing plant. The wood particle separating unit 6 may also comprise other types of separating devices than cyclones 48.

A portion, typically in the range of 30-90%, of the spent drying gas transported by means of the fan 52 in the duct 50 is recirculated, via a recirculation duct 56, to the burner 12 or to the mixing chamber 26 via the ducts 18 and 28, as described hereinbefore. This improves the energy efficiency of the drying plant 1, since a portion of the energy content of the spent drying gas is reused.

The remaining portion of the spent drying gas is forwarded, via a duct 58, to the gas cleaning system 8. The gas cleaning system 8 comprises one wet cleaning device in the form of a wet electrostatic precipitator 60, and, optionally, further treatment units, such as a thermal oxidizing unit 62. In the wet electrostatic precipitator 60, which will be described in more detail hereinafter, the spent drying gas is brought into contact with water and is cooled, such that water vapour and volatile organic substances of the spent drying gas are to a high degree converted, by condensation, from a gaseous state to a liquid state, or even, in the case of the volatile organic substances, a solid state, the condensed products forming liquid droplets, aerosols or solid dust. The wet electrostatic precipitator 60 removes from the spent drying gas the droplets, aerosols and solids which are collected as a sludge at the bottom of the electrostatic precipitator 60. The thermal oxidizing unit 62 may be used for heating the spent drying gas to a high temperature, and for oxidizing any remaining gaseous organic substances.

To ensure that the volatile organic substances are mainly condensed in the wet electrostatic precipitator 60, and not in any other parts of the drying plant 1, a heating gas duct 64 is operative for forwarding, by means of a fan 66, a gas portion in the form of a hot gas, having a temperature of 150-1000° C. directly from the heater 2, for example directly from the mixing chamber 26, or directly from the burner 12, or directly from the steam generator 20, to a mixing position (P), which in the embodiment of FIG. 1 is located in the upper portion of the drop out chamber 40 of the rotary dryer 4. Hence, the hot gas being forwarded in the heating gas duct 64 is led in a by-pass past the rotating drum 38 of the rotary dryer 4. Thus, the hot gas being forwarded in the duct 64 does not take any substantial part in the drying process. In the mixing position, being located in the upper portion of the drop out chamber 40, the hot gas, coming directly from, for example, the mixing chamber 26, having a temperature of, in this example, 300-600° C., and being forwarded via the duct 64, is brought into contact with the spent drying gas coming from the rotating drum 38 of the rotary dryer 4 and having a temperature of typically 100-150° C. to heat the same. By heating the spent drying gas by means of bringing it into contact with the hot gas coming directly from the heater 2 the condensation of volatile organic substances will not occur until the spent drying gas reaches the wet electrostatic precipitator 60.

Without being bound by any theory, it is believed that the conditions, with regard to, e.g., temperature and concentration of volatile organic substances, such as terpenes, of the spent drying gas leaving the rotating drum 38 of the rotary dryer 4, are such that much of the volatile organic substances, such as terpenes, are present at conditions being close to their respective saturated states and they would, hence, be prone to condense in downstream equipment, such as the cyclones 48, and the fan 52, and form unwanted tars and other solid or semi-solid products. The spent drying gas also has a high content of water vapour, which may result in condensation of water on any cold surfaces in, for example, the cyclones 48. Such condensation of water may enhance the condensation of volatile organic substances. By heating the spent drying gas by means of bringing it into direct contact with the hot gas, having a higher temperature than the spent drying gas and coming directly from, for example, the mixing chamber 26, the temperature of the spent drying gas may be increased to such levels that no, or only limited, condensation of volatile organic substances will occur upstream of the wet electrostatic precipitator 60. Furthermore, the gas coming from the heater 2 via the duct 64 also has a lower content of volatile organic substances and water vapour than the spent drying gas and will, in addition to heating the spent drying gas with which it is brought into direct contact, also result in a dilution of the spent drying gas with respect to the concentration of volatile organic substances and water vapour, since the hot gas and the spent drying gas will be at least partly mixed with each other, and, hence, further reduce the risk of any unwanted condensation. Hence, the condensation of volatile organic substances is controlled to occur only, or almost only, in the wet electrostatic precipitator 60, in which the supply of water makes the condensed volatile organic substances easy to handle. It has been found that increasing the temperature of the spent drying gas by 10-50° C., preferably by 10-30° C., is suitable for avoiding, or almost avoiding, condensation of volatile organic substances upstream of the wet electrostatic precipitator 60, and still obtain a suitable energy efficiency of the drying plant 1.

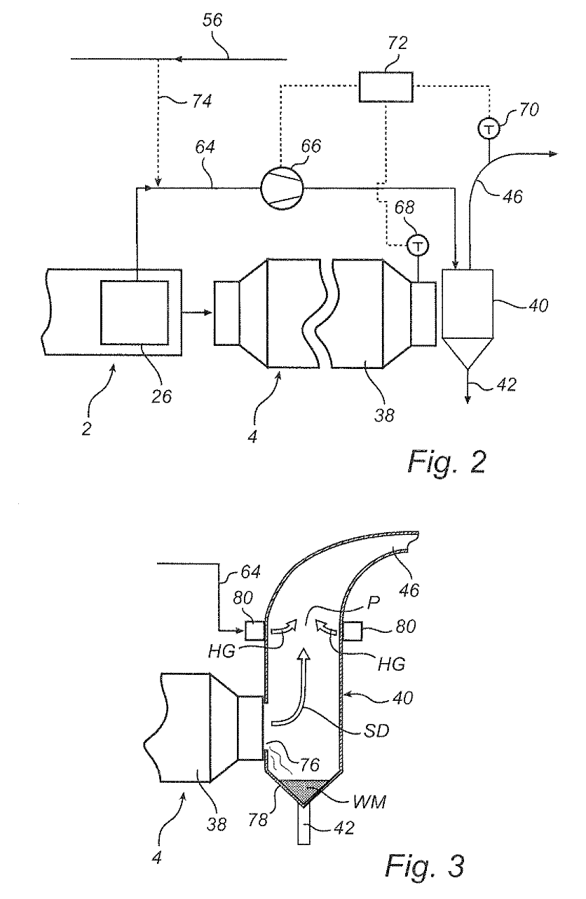

The fact that a substantial amount of the spent drying gas is recirculated, via the ducts 18 or 28 or 74, as will be further described hereinafter with reference to FIG. 2, to the drying process, means that a substantial portion of the energy content of the gas portion forwarded via the heating gas duct 64 to the mixing position is re-used, a fact which contributes to the beneficial energy economy of the drying plant 1.

FIG. 2 is an enlarged schematic side view of the mixing chamber 26 of the heater 2, and of the drop out chamber 40 of the rotary dryer 4. A first temperature sensor 68 is operative for measuring the temperature of the spent drying gas leaving the rotating drum 38 of the rotary dryer 4. The first temperature sensor 68 could be located, for example, at the end of the rotating drum 38 of the rotary dryer 4, at the transition between the rotating drum 38 and the drop out chamber 40, or inside the drop out chamber 40, just upstream of the position of mixing the hot gas forwarded via the heating gas duct 64 with the spent drying gas coming from the rotating drum 38. A second temperature sensor 70 is operative for measuring the temperature of the mixture of the spent drying gas, leaving the rotary dryer 4, and the hot gas forwarded via the heating gas duct 64. The second temperature sensor 70 could, for example, be located in the gas duct 46, or in any one of the gas ducts 50, 56 or 58. The mixing of the hot gas and the spent drying gas will not be complete immediately after the mixing position, and for that reason it is often suitable to utilize several second temperature sensors 70, located in various positions downstream of the mixing position, to obtain an accurate estimation of the temperature of the mixture of the hot gas and the spent drying gas.

A control unit 72 is operative for receiving signals from the two temperature sensors 68 and 70. The control unit 72 calculates the temperature difference between the two temperatures measured and compares the temperature difference to a temperature difference set point. Such a temperature difference set point could typically relate to a temperature difference, assuming well-mixed gases, of 10-30° C. Based on the relation between the measured temperature difference and the temperature difference set point the control unit 72 controls the fan 66 to supply a suitable amount of hot gas from the mixing chamber 26 via the duct 64.

In one example, the first temperature sensor 68 measures a temperature of 120°, and the second temperature sensor 70 measures a temperature of 130° C. Hence, the temperature difference is 10° C. If the temperature difference set point is 20° C., the control unit 72 controls the fan 66 to increase to the flow of the hot gas from the mixing chamber 26 to increase the temperature of the spent drying gas being forwarded to the wood material separating unit 6 via the duct 46.

In accordance with one optional embodiment, a recirculated gas duct 74, illustrated with dashed lines in FIG. 2, is operative for forwarding an amount of recirculated spent drying gas from the recirculation duct 56 to the heating gas duct 64, just upstream of the fan 66. Mixing an amount of the recirculated spent drying gas into the hot gas coming from the mixing chamber 26 decreases the temperature of the gas in the duct 64, for example from an original temperature of 300-600° C. to a temperature of 150 to 500° C. Decreasing the temperature of the hot gas that is to be supplied via the duct 64 has several benefits, including that of decreasing the thermal load on the fan 66, and making it easier to mix the hot gas with the spent drying gas, since the former, when having a lower temperature, is supplied at a higher volumetric flow.

FIG. 3 illustrates the drop out chamber 40 in more detail. The drop out chamber 40 is provided with an inlet 76 through which spent drying gas, denoted SD, and dried wood material, denoted WM, enters the drop out chamber 40 from the rotating drum 38 of the rotary dryer 4. In the drop out chamber 40 the major portion of the dried wood material WM drops down by means of gravitation and is collected at the bottom 78 of the chamber 40. The wood material WM is then transported from the chamber 40 via the pipe 42, as described with reference to FIG. 1. Returning to FIG. 3, the spent drying gas SD is turned upwards after the inlet 76. The hot gas being forwarded via the heating gas duct 64 is brought into contact with the spent drying gas at the mixing position, which is indicated as P in FIG. 3, and is located in the upper portion of the drop out chamber 40. At the upper portion of the chamber 40 there is a mixing arrangement in the form of a ring shaped hot gas supply duct 80 encircling the periphery of the chamber 40. The heating gas duct 64 supplies the hot gas supply duct 80 with the hot gas, which is then supplied, as indicated by hot gas arrows denoted HG, to the chamber 40 via openings around the periphery of the chamber 40. Hence, the spent drying gas SD will, as it travels upwards in the chamber 40, be brought into contact with the hot gas HG and will become surrounded by a “blanket” of hot gas HG, such a blanket being very efficient in preventing any of the spent drying gas SD from coming into contact with the walls of the duct 46, such walls normally having a slightly lower temperature than that of the spent drying gas and thereby posing a risk of causing condensation of volatile organic substances. Hence, it will be appreciated that the hot gas HG and the spent drying gas SD are first brought into contact with each other at the mixing position P, and that mixing of the hot gas HG and the spent drying gas SD will begin at the mixing position P, but that complete mixing, if achieved at all, will not be achieved until a position further downstream of the mixing position P. As can be seen from a reference to FIG. 3, the duct 46 tapers mildly when extending away from the chamber 40 to further decrease the risk of any condensation of substances occurring on the wall of the duct 46 until the spent drying gas SD and the hot gas HG have become thoroughly mixed. In the embodiment of FIG. 3 the mixing arrangement in the form of a ring shaped hot gas supply duct 80 is located in the mixing position P. It will be appreciated that other types of mixing arrangements could be utilized, and also in other positions, including static mixers, other types of connections between the heating gas duct 64 and the chamber 40 or the gas duct 46, etc., and combinations of several mixing arrangements.

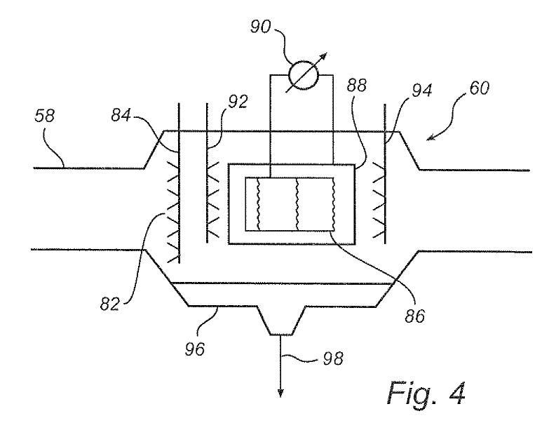

FIG. 4 illustrates a very schematic representation of the wet electrostatic precipitator 60. Wet electrostatic precipitators are per se known from, for example, U.S. Pat. No. 5,624,476. The gas duct 58 forwards the spent drying gas, having been mixed with the hot gas as described with reference to FIG. 3, to a cooling section 82 in which the spent drying gas is rapidly cooled by means of being brought into contact with atomized water supplied via a water supply system 84 comprising a number of water atomizing nozzles. The rapid cooling in the cooling section 82 comprises cooling the spent drying gas from typically 120-170° C. to typically 60-100° C. Such rapid cooling causes much of the volatile organic substances to condense and to form liquid droplets, aerosols or solids. Downstream of the cooling section 82 the wet electrostatic precipitator 60 is provided with emission electrodes, of which only one electrode 86 is illustrated in FIG. 4, and collecting electrode plates, of which only one electrode 88 is shown in FIG. 4. A rectifier 90 applies a voltage between the emission electrodes 86 and the collecting electrode plates 88 such that liquid droplets, aerosols and solid particles are charged on the emission electrodes 86, and are collected on the collecting electrode plates 88. Further water supply devices 92, 94 supply atomized water onto the electrodes 86, 88 and rinse off the collected material. At the bottom 96 of the wet electrostatic precipitator 60 a sludge comprising the collected condensed volatile organic substances is collected. The sludge is pumped away from the wet electrostatic precipitator 60 via a pipe 98 for further treatment, such as land filling, incineration, etc.

It will be appreciated that numerous variants of the above described embodiments are possible within the scope of the appended claims.

Above it has been described that the mixing position P, being the position at which the gas portion, i.e. the hot gas HG forwarded from the heater 2 via the duct 64, is brought into contact with the spent drying gas SD coming from the rotating drum 38 of the rotary dryer 4, is located in the drop out chamber 40. It will be appreciated that the mixing position could also be located in other positions. For example, the mixing position could be located in the actual transition between the rotating drum 38 and the drop out chamber 40, or in the duct 46 located immediately downstream of the drop out chamber 40.

Above it has been described that the gas portion forwarded to the mixing position P via the duct 64 is forwarded from the heater 2. While this is a preferred embodiment, it is also possible to forward the gas portion from an external burner, steam heater, oil heater or similar device. The latter may be an option in, for example, cases where the capacity of the heater 2 is not sufficient for providing the gas portion to be forwarded to the mixing position, or where there is a surplus of steam or hot oil available.

Hereinbefore it has been described that the wet cleaning system being operative for cooling the spent drying gas by means of mixing it with water, and subsequently removing the condensed volatile organic substances, is a wet electrostatic precipitator 60. It will be appreciated that other types of wet cleaning devices could also be utilized for this purpose. One such example is a wet venturi scrubber, in which water is mixed with the spent drying gas, which is subsequently forced through a venturi throat. An example of a wet venturi scrubber is disclosed in U.S. Pat. No. 3,908,969, under reference numerals 41 and 44 of that document. Also other types of wet cleaning devices could be used, and also combinations of several wet cleaning devices. For example, a wet venturi scrubber could be utilized for cooling the spent drying gas, saturating it with water, and removing the coarse solid particles and large liquid droplets therefrom, with a wet electrostatic precipitator being located downstream of the wet venturi scrubber for removing the smallest particles, droplets, and any aerosols formed.

Above it has been described that the control unit 72 controls the temperature of the spent drying gas downstream of the mixing position, i.e., downstream of the drop out chamber 40, by controlling the amount of hot gas being forwarded, via the duct 64 and by means of the fan 66, from the heater 2 to the mixing position P. It will be appreciated that the control unit 72 may also control, in addition to controlling the amount of gas being forwarded in the gas duct 64, or as alternative to controlling the amount of gas being forwarded in the gas duct 64, the temperature of the gas being forwarded in the gas duct 64. The control of the temperature of the gas being forwarded in the gas duct 64 could be performed by controlling the operation of the heater 2, or as, as alternative, by controlling the amount of recirculated spent drying gas being added to the hot gas in the duct 64 via the recirculated gas duct 74. Hence, the control unit 72 may control the temperature or the amount of the hot gas being forwarded in the duct 64 to the mixing position P.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

The invention claimed is:

1. A wood material drying plant being operative for drying a wood material and comprising a heater generating a hot drying gas, a rotary dryer bringing, in a rotating drum thereof, the hot drying gas into contact with the wood material to be dried, a wood particle separating unit separating entrained wood particles from the spent drying gas, and a gas cleaning system removing pollutants from the spent drying gas, wherein the wood material drying plant includes a heating gas duct which forwards a gas portion to a mixing position (P) located between the rotating drum of the rotary dryer and the wood particle separating unit, said gas portion having a higher temperature than the spent drying gas, and mixing said gas portion and said spent drying gas at the mixing position (P), such that the temperature of the spent drying gas is increased.

2. A wood material drying plant according to claim 1, further comprising a first temperature sensor measuring the temperature of the spent drying gas upstream of said mixing position (P) to which the gas portion is forwarded, and a second temperature sensor measuring the temperature of the spent drying gas downstream of said mixing position (P) to which the gas portion is forwarded, a control unit controlling the amount and/or the temperature of the gas portion being forwarded to said mixing position (P) based on the temperatures measured by said first and second temperature sensors.

3. A wood material drying plant according to claim 1, wherein said heating gas duct forwards the gas portion from the heater generating the hot drying gas for the rotary dryer to said mixing position (P).

4. A wood material drying plant according to claim 1, wherein said heating gas duct forwarding the gas portion to a rotary dryer drop out chamber in which at least a portion of the dried wood material is separated from the spent drying gas.

5. A wood material drying plant according to claim 4, wherein said heating gas duct is connected to a ring shaped duct at least partly encircling the drop out chamber and being operative for supplying the gas portion around at least a part of the periphery of the drop out chamber.

6. A wood material drying plant according to claim 1, wherein said gas cleaning system comprises a wet cleaning device cooling the spent drying gas by mixing the spent drying gas with water and removing condensed volatile organic substances from the spent drying gas.

7. A wood material drying plant according to claim 1, further comprising a recirculated gas duct being connected to said heating gas duct and being operative for mixing an amount of recirculated spent drying gas into the gas portion being forwarded to the mixing position (P).

8. A wood material drying plant according to claim 1, wherein the wood particle separating unit comprises at least one cyclone.

9. A method of controlling the operation of a wood material drying plant being operative for drying a wood material and comprising a heater generating a hot drying gas, a rotary dryer bringing, in a rotating drum thereof, the hot drying gas into contact with the wood material to be dried, a wood particle separating unit separating entrained wood particles from the spent drying gas, and a gas cleaning system removing pollutants from the spent drying gas, the method further comprising:
forwarding a gas portion to a mixing position (P) located between the rotating drum of the rotary dryer and the wood material separating unit;
mixing the gas portion, having a higher temperature than the spent drying gas leaving the rotating drum of the rotary dryer, with the spent drying gas to increase the temperature of the spent drying gas, and
feeding the mixture of the spent drying gas and the gas portion to the separating unit.

10. A method according to claim 9, further comprising measuring, upstream of the mixing position (P), the temperature of the spent drying gas and measuring, downstream of the mixing position (P), the temperature of the mixture of the spent drying gas with said gas, and controlling the amount and/or the temperature of the gas portion forwarded to the mixing position (P) based on said temperatures.

11. A method according to claim 9, wherein said gas portion is forwarded to the mixing position (P) from the heater generating the hot drying gas for the rotary dryer.

12. A method according to claim 9, wherein the amount and/or temperature of the gas portion being forwarded to the mixing position (P) is controlled so as to increase the temperature of the spent drying gas leaving the rotating drum of the rotary dryer by 10° C. to 50° C.

13. A method according to claim 9, wherein at least a portion of the mixture of the spent drying gas and the gas portion is recirculated, from a position located downstream of said mixing position (P), to the heater and/or to the heating gas duct forwarding the gas portion from the heater to the mixing position (P).

14. A method according to claim 9, wherein the gas portion being forwarded to the mixing position (P) has a temperature of 150° C. to 1000° C.

15. A method according to claim 9, wherein the gas portion is forwarded from the heater to the mixing position (P) and is mixed with an amount of recirculated spent drying gas to decrease the temperature of the gas portion.

16. A method according to claim 9, wherein the spent drying gas leaving the wood particle separating unit is cooled by being mixed with water in the gas cleaning system, such that at least a portion of the volatile organic substances of the spent drying gas are condensed.

17. A method according to claim 9, wherein said mixing position (P) is located downstream of a position in which at least 90% of the dried wood material (WM) is separated from the spent drying gas (SD).

18. A method according to claim 9, wherein the wood particle separating unit comprises at least one cyclone.

19. A wood material drying plant comprising:
a source of drying gas;
a rotary drum dryer receiving the drying gas from the source and receiving a wood material and discharges the wood material and spent drying gas to a discharge conduit, wherein the wood material is dried by the drying gas in the rotary drum dryer;
a wood particle separating unit coupled to the discharge conduit and separating entrained wood particles from the spent drying gas;
a heating gas duct directing a gas portion to the discharge conduit;
a mixing position in the discharge conduit at which the gas portion from the heating gas duct mixes with the spent drying gas from the rotary drum, wherein the gas portion is at a higher temperature than the spent drying gas, and
wherein heat from the gas portion to the spent drying gas at the mixing position (P) in the discharge conduit.

20. The wood material drying plant of claim 19 further comprising a first temperature sensor measuring a temperature of the spent drying gas upstream of said mixing position (P) and a second temperature sensor measuring the temperature of the spent drying gas downstream of said mixing position (P), and a control unit controlling the amount and/or the temperature of the gas portion flowing to said mixing position (P) based on the temperatures measured by said first and second temperature sensors.

21. The wood material drying plant of claim 19 wherein the discharge conduit comprises a drop out chamber and at least one conduit connecting the rotary drum dryer, drop out chamber and wood particle separating unit.

22. The wood material drying plant of claim 19 wherein the gas portion is a portion of the drying gas, and the heating gas duct has an inlet coupled to the source.
